(19) United States
(12) Patent Application Publication
(10) Pub. No.: US 2025/0291463 A1
(43) Pub. Date: Sep. 18, 2025

(54) DISPLAY DEVICE USING RECOMMENDED SETTING INFORMATION, AND CONTROL METHOD THEREOF

(71) Applicant: Samsung Electronics Co., Ltd., Suwon-si (KR)

(72) Inventors: Junghee KIM, Suwon-si (KR); Kyungsoo PARK, Suwon-si (KR); Kibum SEONG, Suwon-si (KR); Sangki YOON, Suwon-si (KR); Kisung LEE, Suwon-si (KR); Yongseok JANG, Suwon-si (KR); Hyunyoung JANG, Suwon-si (KR)

(21) Appl. No.: 19/225,281

(22) Filed: Jun. 2, 2025

Related U.S. Application Data
(63) Continuation of application No. PCT/KR2023/019899, filed on Dec. 5, 2023.

(30) Foreign Application Priority Data
Jan. 12, 2023 (KR) 10-2023-0004974

(51) Int. Cl. G06F 3/0482; G06F 3/147; H04N 7/025

(52) U.S. Cl. CPC G06F 3/0482; G06F 3/147; H04N 7/0255

(57) ABSTRACT

A display device may include: a first communication interface; and at least one processor that individually and/or collectively acquires, by means of the first communication interface, first identification information corresponding to an external device connected to the display device and second identification information corresponding to the display device, acquires interface information corresponding to the first communication interface, acquires recommended setting information on the basis of the first identification information, the second identification information, and the interface information, and changes settings of the display device on the basis of the recommended setting information, wherein the recommended setting information includes at least one of an image quality-related recommended setting and a sound-related recommended setting of the display device corresponding to the interface information and the combination of the display device and the external device.

### CROSS-REFERENCE TO RELATED APPLICATIONS

This application is a continuation application of International Application No. PCT/KR2023/019899, filed on Dec. 5, 2023, in the Korean Intellectual Property Receiving Office, and claiming priority to Korean Patent Application No. 10-2023-0004974 filed Jan. 12, 2023, the disclosures of which are all hereby incorporated by reference herein in their entireties.

### TECHNICAL FIELD

Certain example embodiments may relate to a display device and/or a control method thereof, and for example, to a display device that changes a setting of the display device based on recommended setting information and/or a control method thereof.

### BACKGROUND ART

Recently, various electronic devices are being developed due to the development of electronic technology.

In particular, types of a source device connected to a display device and providing content thereto and a sound output device assisting output of the display device are becoming more diverse.

A combination of the display device and an external device connectable to the display device is becoming more diverse, and types of a connection terminal between the display device and the external device are also becoming more diverse. Accordingly, the display device provides various setting menus allowing a user to directly set.

However, many users have difficulty in manually changing the various setting menus, and clearly understanding what each of the various setting menus indicates.

A manufacturer may distribute appropriate setting values to the various setting menus in consideration of various combinations, which method also has a limitation.

Accordingly, various demands exist for methods for acquiring the appropriate setting value for each of the various setting menus and automatically applying the same in consideration of the various combinations between the display device and the external device, and a method by which the external device is connected thereto (e.g., connection terminal).

### SUMMARY

According to an example embodiment, there may be provided a display device that may include: a first communication interface comprising communication circuitry; and at least one processor, comprising processing circuitry, configured to acquire first identification information corresponding to an external device connected, directly or indirectly, to the display device via the first communication interface and second identification information corresponding to the display device, acquire interface information corresponding to the first communication interface, acquire recommended setting information on the basis of the first identification information, the second identification information, and the interface information, and change a setting of the display device on the basis of the recommended setting information, wherein the recommended setting information may include at least one of a combination of the display device and the external device or the image quality-related recommended setting or sound-related recommended setting of the display device that corresponds to the interface information.

According to an example embodiment, there may be provided a control method of a display device, which method may include: acquiring first identification information corresponding to an external device connected, directly or indirectly, to the display device via a first communication interface of the display device and second identification information corresponding to the display device; acquiring interface information corresponding to the first communication interface; acquiring recommended setting information on the basis of the first identification information, the second identification information, and the interface information; and changing a setting of the display device on the basis of the recommended setting information, wherein the recommended setting information may include at least one of a combination of the display device and the external device or the image quality-related recommended setting or sound-related recommended setting of the display device that corresponds to the interface information.

According to an example embodiment, there may be provided a computer-readable medium including a program for performing a control method of a display device, wherein the method may include acquiring first identification information corresponding to an external device connected to the display device via a first communication interface of the display device and second identification information corresponding to the display device, acquiring interface information corresponding to the first communication interface; acquiring recommended setting information on the basis of the first identification information, the second identification information, and the interface information, and changing a setting of the display device on the basis of the recommended setting information, and the recommended setting information may include at least one of a combination of the display device and the external device or the image quality-related recommended setting or sound-related recommended setting of the display device that corresponds to the interface information.

### BRIEF DESCRIPTION OF DRAWINGS

FIG. 1 is a diagram for describing a display and an external device according to an example embodiment.

FIG. 2 is a block diagram showing a configuration of the display device according to an example embodiment.

FIG. 3 is a sequence diagram for describing operations among the display device, the external device, and a server according to an example embodiment.

FIG. 4 is a diagram for describing a neural network model that may collect setting information and acquire recommended setting information according to an example embodiment.

FIG. 5 is a diagram for describing a neural network model that acquires the recommended setting information by using surrounding environment information according to an example embodiment.

FIG. 6 is a diagram for describing an image quality-related recommended setting according to an example embodiment.

FIG. 7 is a diagram for describing an image quality-related recommended setting according to an example embodiment.

FIG. 8 is a diagram for describing a sound-related recommended setting according to an example embodiment.

FIG. 9 is a diagram for describing a list of the plurality of image quality-related recommended settings according to an example embodiment.

FIG. 10 is a diagram for describing a list of the plurality of sound-related recommended settings according to an example embodiment.

FIG. 11 is a diagram for describing a list of the plurality of recommended settings according to an example embodiment.

FIG. 12 is a diagram for describing the external device according to an example embodiment.

FIG. 13 is a flowchart for describing a control method of a display device according to an example embodiment.

### DETAILED DESCRIPTION

Hereinafter, certain example embodiments are described in detail with reference to the accompanying drawings.

General terms currently widely used are selected as terms used in embodiments of the present disclosure in consideration of their functions in the present disclosure, and may be changed based on the intentions of those skilled in the art or a judicial precedent, the emergence of a new technique, or the like. In addition, in a specific case, terms arbitrarily selected by an applicant may be present. In this case, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

In the specification, an expression “have”, “may have”, “include”, “may include”, or the like indicates the presence of a corresponding feature (for example, a numerical value, a function, an operation, or a component such as a part), and does not exclude the presence of an additional feature.

An expression, “at least one of A or/and B” may indicate either “A or B”, or “both of A and B.”

Expressions “first”, “second”, or the like used in the present disclosure may qualify various components regardless of the sequence or importance of the components. These expressions are used only to distinguish one component and another component from each other, and do not limit the corresponding components.

If any component (for example, a first component) is described as being “(operatively or communicatively) coupled with/to or connected to” another component (for example, a second component), it should be understood that any component may be directly coupled to another component or may be coupled to another component through yet another component (for example, a third component). Thus, for example, “connected” as used herein covers direct and indirect connections.

A term of a singular number may include its plural number unless explicitly indicated otherwise in the context. It should be understood that a term “include”, “formed of”, or the like used in this application specifies the presence of features, numerals, steps, operations, components, parts, or combinations thereof, mentioned in the specification, and does not preclude the presence or addition of one or more other features, numerals, steps, operations, components, parts, or combinations thereof.

In the present disclosure, a “module” or a “˜er/˜or” may perform at least one function or operation, and be implemented by hardware, software, or a combination of hardware and software. In addition, a plurality of “modules” or a plurality of “˜ers/˜ors” may be integrated in at least one module to be implemented by at least one processor (not shown) except for a “module” or a “˜er/or” that needs to be implemented by specific hardware.

In the specification, a term “user” may refer to a person using an electronic device or a device using the electronic device (e.g., artificial intelligence electronic device).

Hereinafter, an example embodiment is described in more detail with reference to the accompanying drawings.

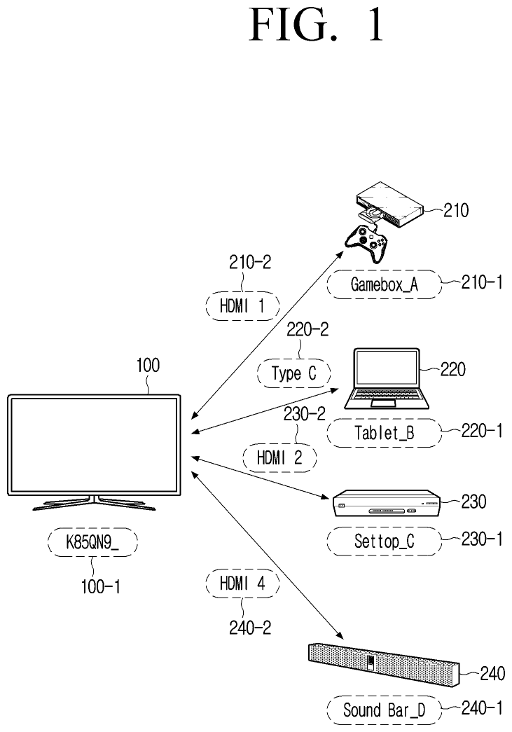

FIG. 1 is a diagram for describing a display and an external device according to an example embodiment.

Referring to FIG. 1, a display device 100 according to an example embodiment may provide content. The display device 100 may be implemented as a television (TV), is not limited thereto, and may be applied to any device having a display function, such as a video wall, a large format display (LFD), a digital signage, a digital information display (DID), or a projector display. In addition, the display device 100 may be implemented in any of various types of displays such as a liquid crystal display (LCD), an organic light-emitting diode (OLED), liquid crystal on silicon (LCoS), digital light processing (DLP), a quantum dot (QD) display panel, quantum dot light-emitting diodes (QLED).

Meanwhile, the display device 100 according to an example embodiment may be connected to an external device 200 and may receive the content from the external device 200.

Here, the external device 200 may be implemented as an electronic device such as a source device (e.g., a set-top box, a cloud server, or an over-the-top (OTT) media service server), a home automation control panel, a security control panel, a media box (e.g., Samsung HomeSync™, AppleTV™, or Google TV™), a game console (e.g., Xbox™ or PlayStation™), an electronic dictionary, an electronic key, a camcorder, or an electronic picture frame. However, the external device 200 may not be limited thereto, and include at least one of a TV, a user terminal device, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a medical device, a camera, a virtual reality (VR) implementation device, or a wearable device. Here, the wearable device may be implemented as at least one of an accessory type (e.g., a watch, a ring, a bracelet, an anklet, a necklace, glasses, a contact lens, or a head-mounted device (HMD)), a fabric or clothing-integrated type (e.g., an electronic garment), a body-attached type (e.g., a skin pad or tattoo), or a bio-implantable circuit.

In addition, the external device 200 may include an output device in addition to an input device (e.g., the source device) that provides the content to the display device 100. Here, the output device may include a sound output device (e.g., a speaker or a sound bar), a device having a display function (e.g., a projector or an auxiliary display device), a printer, or the like.

According to an example embodiment, the display device 100 may include a communication interface (hereinafter, a first communication interface) connectable to the external device 200.

For example, the display device 100 may include the plurality of first communication interfaces, and the plurality of first communication interfaces may respectively be connected to different external devices (e.g., a first external device 210 to a fourth external device 240).

Referring to FIG. 1, each of the plurality of first communication interfaces may be a communication interface according to the same standard, or may be a communication interface according to a different standard. For example, among the plurality of first communication interfaces, one first communication interface connected to the first external device 210 may be a communication interface according to an HDMI 2.1 standard, and among the plurality of first communication interfaces, one first communication interface connected to the second external device 220 may be a communication interface according to a universal serial bus (USB) Type-C standard.

However, this configuration is an example, and the present disclosure is not limited thereto. For example, among the plurality of first communication interfaces, one first communication interface may be a communication interface according to any of various standards (or versions), such as red-green-blue (RGB), digital visual interface (DVI), display port (DP), high-definition multimedia interface (HDMI), USB Type-C, or Thunderbolt™.

If the first external device 210 is connected thereto via the first communication interface, the display device 100 according to an example embodiment may acquire first identification information 210-1 corresponding to the first external device 210 (e.g., “Gamebox_A”), second identification information 100-1 corresponding to the display device 100 (e.g., “K85QN9_”), and interface information 210-2 corresponding to the first communication interface to which the first external device 210 is connected.

Here, the identification information corresponding to the external device 200 may include a product name (or model name), a product number, or a serial number (e.g., serial number) for identifying the external device 200. The identification information corresponding to the display device 100 may also include a product name (or model name), a product number, or a serial number (e.g., serial number) for identifying the display device 100.

Next, the display device 100 may acquire recommended setting information for the display device 100 on the basis of the first identification information 210-1, the second identification information 100-1, and the interface information 210-2.

As an example, although changeable settings of the display device 100 are increasing, it is difficult for a user to find an appropriate and optimized setting value for each of various settings of the display device 100 in consideration of all of characteristics of the display device 100, characteristics of the external device 200 providing the content to the display device 100, characteristics of the first communication interface to which the external device 200 is connected, and the like.

For example, if the external device 200 is connected to the display device 100 via the first communication interface according to an HDMI 2.0 standard among the plurality of first communication interfaces included in the display device 100, it is difficult for the user to manually change the appropriate setting value for each of the various settings of the display device 100 in consideration of the characteristics of the first communication interface according to the HDMI 2.0 standard (e.g., maximum supported resolution/frequency and maximum transmission bandwidth).

As another example, it is difficult for the user to manually change the appropriate setting value for each of the various settings of the display device 100 in consideration of a specification of the external device 200 providing the content to the display device 100 (e.g., output resolution (up to 4K Ultra High Definition (HD)) or high dynamic range (HDR) support).

According to the various embodiments of the present disclosure, the display device 100 may acquire the recommended setting information on the basis of the identification information corresponding to the display device 100 (hereinafter, the second identification information), the identification information corresponding to the external device 200 (hereinafter, the first identification information), and the interface information corresponding to the first communication interface to which the external device 200 is connected, and change the setting of the display device 100 on the basis of the acquired recommended setting information.

Accordingly, rather than the user directly searching for and changing the appropriate and optimized setting value for each of the various settings of the display device 100, the display device 100 may acquire the recommended setting information in consideration of the characteristics of the display device 100, the characteristics of the external device 200 providing the content to the display device 100, and the characteristics of the first communication interface to which the external device 200 is connected, and then appropriately change the setting value for each of the various settings of the display device 100 based on the recommended setting information, thereby increasing user convenience.

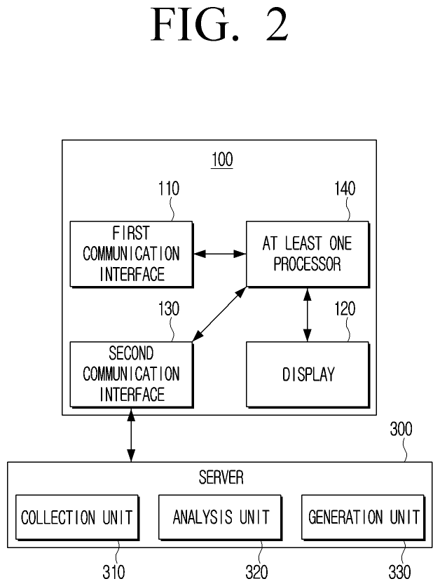

FIG. 2 is a block diagram showing a configuration of the display device according to an example embodiment.

Referring to FIG. 2, the display device 100 may include a first communication interface 110, a display 120, a second communication interface 130, and at least one processor 140.

First, the first communication interface 110 may include input/output interfaces (or input/output terminals) according to various standards. For example, the first communication interface 110 may be one of a high-definition multimedia interface (HDMI), a mobile high-definition link (MHL), a universal serial bus (USB), a display port (DP), Thunderbolt, a video graphics array (VGA) port, an RGB port, a D-subminiature (D-SUB), or a digital visual interface (DVI). The first communication interface 110 may input and output at least one of audio or video signals.

According to an implementation example, the input/output interface may include a port that inputs/outputs only the audio signals and a port that inputs/outputs only the video signals as separate ports, or may be implemented as a single port that inputs/outputs both the audio signals and video signals. Meanwhile, the display device 100 may receive at least one of the audio or video signals from the external device 200 (e.g., the source device) or transmit the same to the external device 200 (e.g., the output device) via the first interface 110.

According to an example embodiment, the display device 100 may include the plurality of first communication interfaces, and respective standards of the plurality of first communication interfaces may be the same or different.

For example, the display device 100 may include a total of six first communication interfaces 110 (for example, the first communication interface 110 according to HDMI 2.1 may be equipped with three ports (HDMI 1 to HDMI 3), the first communication interface 110 according to HDMI 2.0 may be equipped with one port (HDMI 4), the first communication interface 110 according to USB type-C may be equipped with one port (USB 1), and the first communication interface 110 according to USB type-A may be equipped with one port (USB 2)), which is an example for convenience of description, and the present disclosure is not limited thereto.

As an example, the first communication interface 110 may be connected to the external device 200, receive at least one of the audio signal or the video signal (hereinafter, the content) from the external device 200, output the video signal through the display 120 under control of at least one processor 140, and output the audio signal through either an internal speaker or the output device (e.g., the sound output device connected to the display device 100), as described below.

The display 120 according to an example embodiment may be implemented as any of various types of displays, such as a liquid crystal display (LCD) panel, an organic light-emitting diode (OLED) panel, a liquid crystal on silicon (LCoS) panel, a digital light processing (DLP) panel, a quantum dot (QD) display panel, a quantum dot light-emitting diode (QLED) panel, a micro light-emitting diode (uLED) panel, or a mini LED panel.

Meanwhile, the display device 100 may be implemented as a touchscreen coupled with a touch sensor, a flexible display, a rollable display, a three-dimensional (3D) display, a display in which a plurality of display modules are physically connected to each other, or the like.

The second communication interface 130 according to an example embodiment may, for example, the second communication interface 130 may communicate with an external server (e.g., web hard), the external device (e.g., the user terminal device), or an external storage medium (e.g., a USB memory) via a communication method such as access point (AP)-based wireless fidelity (Wi-Fi, Wireless LAN network), Bluetooth, Zigbee, wired/wireless local area network (LAN), wide area network (WAN), Ethernet, IEEE 1394, high-definition multimedia interface (HDMI), universal serial bus (USB), mobile high-definition link (MHL), audio engineering society/European broadcasting union (AES/EBU) communication, optical communication, or coaxial communication.

As an example, at least one processor 140 may control overall operations of the display device 100.

According to an example embodiment, at least one processor 140 may be implemented as a digital signal processor (DSP), a microprocessor, or a timing controller (TCON) for processing digital signals. However, the processor 140 is not limited thereto, and may include or be defined by one or more of a central processing unit (CPU), a micro controller unit (MCU), a micro processing unit (MPU), a controller, an application processor (AP), a communication processor (CP), an advanced RISC machine (ARM) processor, and an artificial intelligence (AI) processor. In addition, the processor 140 may be implemented in a system-on-chip (SoC) or a large scale integration (LSI), in which a processing algorithm is embedded, or may be implemented in the form of a field programmable gate array (FPGA). The processor 130 may perform various functions by executing computer-executable instructions stored in a memory.

At least one processor 140 may include at least one of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. At least one processor 140 may control one or any combination of other components of the electronic device and perform an operation related to the communication or data processing. At least one processor 140 may execute at least one program or instruction stored in the memory. For example, at least one processor 140 may perform a method according to an example embodiment by executing at least one instruction stored in the memory.

If the method according to an example embodiment may include a plurality of operations, the plurality of operations may be performed by one processor, or may be performed by a plurality of processors. For example, if a first operation, a second operation, and a third operation are performed by the method according to an embodiment, the first operation, the second operation, and the third operation may all be performed by a first processor. Alternatively, the first operation and the second operation may be performed by the first processor (for example, a general-purpose processor), and the third operation may be performed by a second processor (for example, an artificial intelligence-only processor).

At least one processor 140 may be implemented as a single-core processor including a single core, or may be implemented as at least one multi-core processor including multiple cores (e.g., homogeneous multi-cores or heterogeneous multi-cores). If at least one processor 140 is implemented as the multi-core processor, each of the multiple cores included in the multi-core processor may include a processor-internal memory such as a cache memory or an on-chip memory, and a common cache shared by the multiple cores may be included in the multi-core processor. In addition, each (or some) of the multiple cores included in the multi-core processor may independently read and perform a program instruction for implementing the method according to an example embodiment, or all (or some) of the multiple cores may be linked with each other to read and perform the program instruction for implementing the method according to an example embodiment.

If the method according to an example embodiment may include a plurality of operations, the plurality of operations may be performed by one core among the multiple cores included in the multi-core processor, or may be performed by the multiple cores. For example, if the first operation, the second operation, and the third operation are performed using the method according to an embodiment, the first operation, the second operation, and the third operation may all be performed by a first core included in the multi-core processor. Alternatively, the first operation and the second operation may be performed by the first core included in the multi-core processor, and the third operation may be performed by a second core included in the multi-core processor.

In the embodiments of the present disclosure, the processor may indicate a system-on-chip (SoC) in which at least one processor and other electronic components are integrated with each other, the single-core processor, the multi-core processor, or the core included in the single-core processor or the multi-core processor. Here, the core may be implemented as the CPU, the GPU, the APU, the MIC, the DSP, the NPU, the hardware accelerator, the machine learning accelerator, or the like. However, the embodiments of the present disclosure are not limited thereto.

In particular, if the first external device 210 is connected thereto via the first communication interface 110, at least one processor 140 may acquire the first identification information 210-1 (e.g., “Gamebox_A”) corresponding to the first external device 210, the second identification information 100-1 (e.g., “K85QN9_”) corresponding to the display device 100, and the interface information 210-2 corresponding to the first communication interface 110 to which the first external device 210 is connected, and control the second communication interface 130 to allow the first identification information 210-1, the second identification information 100-1, and the interface information 210-2 to be transmitted to the external server 300 via the second communication interface 130.

As an example, at least one processor 140, comprising processing circuitry, may acquire the first identification information 210-1 corresponding to the first external device 210 if its connection to the first external device 210 is identified via one first communication interface 110 among the plurality of first communication interfaces 110 (e.g., Plug and play, PnP). Each interface herein may comprise interface circuitry.

As another example, at least one processor 140 may acquire the first identification information 210-1 corresponding to the first external device 210 providing content currently being displayed if one first communication interface 110 among the plurality of first communication interfaces 110 is selected in response to a user command, and the content received from the first external device 210 connected thereto via the selected first communication interface 110 is currently being displayed.

As yet another example, at least one processor 140 may acquire the first identification information 210-1 corresponding to the first external device 210 if its connection to the first external device 210 via the first communication interface 110 is identified in response to the user command (e.g., its connection to the first external device 210 is identified in response to the user command input during an out-of-box experience (OOBE) phase).

However, this configuration is only an example, and at least one processor 140 may identify its connection to the external device 200 (e.g., the first external device 210) via one first communication interface 110 among the plurality of first communication interfaces 110 by using various methods, and acquire identification information 200-1 corresponding to the external device 200 connected thereto via one first communication interface 110.

Next, at least one processor 140 may acquire the identification information 100-1 corresponding to the display device 100. As described above, the identification information 200-1 corresponding to the external device 200 and the identification information 100-1 corresponding to the display device 100 may each include a product name (or model name), a product number, a serial number (e.g., serial number), extended display identification data (EDID), or the like to distinguish the corresponding device from other devices.

Next, at least one processor 140 may acquire the interface information corresponding to the first communication interface 110 (e.g., HDMI 1) to which the external device 200 is connected (referring to FIG. 1, the first communication interface 110 to which the first external device 210 is connected). Here, the interface information may include standard information (e.g., HDMI, USB, or DVI) and version information (or type information) (e.g., ver. 2.0, ver. 2.1, type-A, or type-C).

Next, at least one processor 140 may control the second communication interface 130 to transmit, to the external server 300, the first identification information, the second identification information, and the interface information.

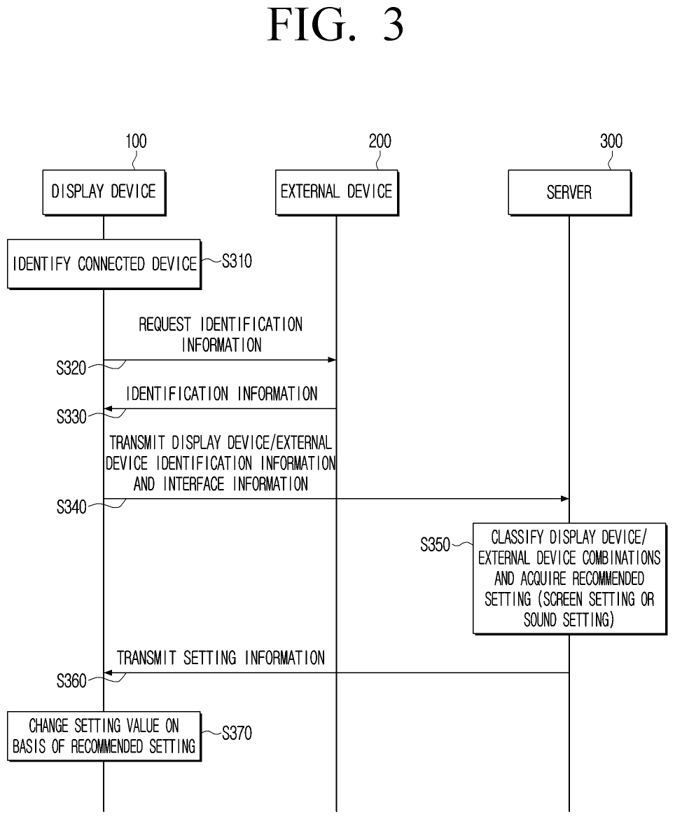

As an example, at least one processor 140 may acquire the recommended setting information via the second communication interface 130, which is described in detail with reference to FIG. 3.

FIG. 3 is a sequence diagram for describing operations among the display device, the external device, and a server according to an example embodiment.

Referring to FIG. 3, the display device 100 may identify its connection to the external device 200 (S310). For example, at least one processor 140 may identify its connection to the external device 200 by using the PnP function, or may identify its connection to the external device 200 in response to the user command (for example, a command to start identifying the newly connected external device 200).

Next, at least one processor 140 may request the external device 200 for the identification information corresponding to the external device 200, that is, the first identification information (S320), and may receive the first identification information from the external device 200 via the first communication interface 110 (S330).

Next, at least one processor 140 may acquire the first identification information received at step S330 and the identification information corresponding to the display device 100, that is, the second identification information, and control the second communication interface 130 to transmit the first identification information, the second identification information, and the interface information corresponding to the first communication interface 110 to a server 300 (S340).

Next, at least one processor 140 may receive the recommended setting information from the server 300 (S360), and change the setting value of the display device 100 on the basis of the recommended setting information (S370).

Here, the received recommended setting information may include at least one of a combination of the display device 100 and the external device 200 or the image quality-related recommended setting or sound-related recommended setting of the display device 100 that corresponds to the interface information, is not limited thereto, and may also include at least one of other setting information related to a user environment.

According to an example embodiment, the server 300 may receive the first identification information, the second identification information, and the interface information from the display device 100, and acquire the recommended setting information corresponding thereto. Next, the server 300 may transmit the recommended setting information to the display device 100.

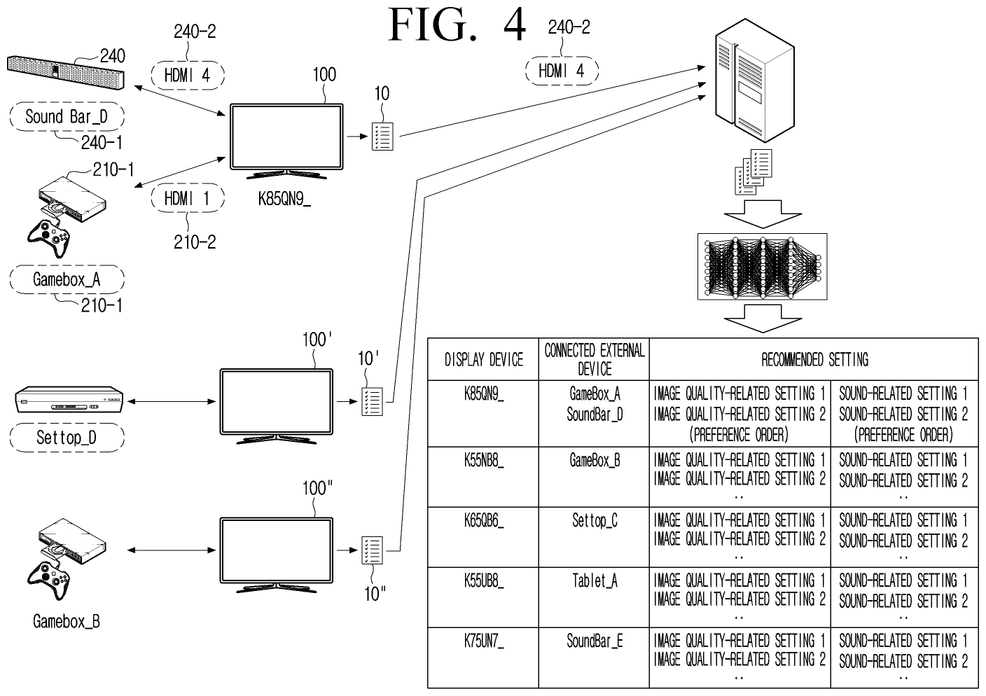

Hereinafter, a method by which the server 300 acquires the recommended setting information is described in detail with reference to FIG. 4.

FIG. 4 is a diagram for describing a neural network model that may collect setting information and acquire the recommended setting information according to an example embodiment.

Referring to FIG. 4, at least one processor 140 included in the display device 100 may acquire setting information 10 including at least one of the current image quality-related setting or sound-related setting of the display device 100.

As an example, the setting information 10 may further include the identification information of the display device 100 (e.g., “K85QN9_”), the identification information 210-1 of the first external device 210 connected to the display device 100 (e.g., “Gamebox_A”), the interface information 210-2 of the first communication interface 110 (e.g., HDMI 1) to which the first external device 210 is connected, identification information 240-1 of the fourth external device 240 (e.g., “Sound Bar_D”), and interface information 240-2 of the first communication interface 110 (e.g., HDMI 4) to which the fourth external device 240 is connected.

Next, at least one processor 140 may transmit the setting information 10 to the external server 300.

Referring to FIG. 2, the collection unit 310 included in the server 300 may receive corresponding setting information 10′ and 10″ from the plurality of other display devices 100′ and 100″, respectively, in addition to the display device 100.

As an example, the collection unit 310 may acquire the plurality of setting information 10, 10′, and 10″, and referring to FIG. 2, the analysis unit 320 included in the server 300 may classify at least one setting information among the plurality of image quality-related settings, the plurality of sound-related settings, and other user environment settings included in the plurality of setting information 10, 10′, and 10″.

As an example, the analysis unit 320 may classify the plurality of image quality-related settings and the plurality of sound-related settings included in the plurality of setting information 10, 10′, and 10″ based on i) the combination of the display device and the external device connected to the display device, and ii) the communication interface used for the connection between the display device and the external device.

### Classification of the Plurality of Image Quality-Related Settings

First, the analysis unit 320 may acquire a plurality of groups by classifying (or clustering) the plurality of image quality-related settings based on i) the combination of the display device and the external device connected to the display device, and ii) the communication interface used for the connection between the display device and the external device. However, the analysis unit 320 is not limited thereto, and may acquire the plurality of groups by classifying the plurality of image quality-related settings based on iii) a combination of the plurality of external devices 200 connected to the display device 100.

As an example, each of the plurality of groups may include at least one image quality-related setting.

For example, a first group (e.g., a group in which the display device is connected to the external device based on i) the combination of the display device “K85QN9_” and the external devices “GameBox_A” and “SoundBar_D” and ii) the first communication interface 110 according to the HDMI 2.1 standard) among the plurality of groups may include an “image quality-related setting 1” and an “image quality-related setting 2”.

As an example, the analysis unit 320 may acquire preference information corresponding to the plurality of image quality-related settings (e.g., the “image quality-related setting 1” and the “image quality-related setting 2”) included in the first group on the basis of a frequency (or the number of repetitions) of each of the “image quality-related setting 1” and the “image quality-related setting 2”. For example, the “image quality-related setting 1” selected (or set) by a relatively large number of users has a higher preference than the “image quality-related setting 2” selected by a relatively small number of users, and the analysis unit 320 may thus recommend the “image quality-related setting 1” in preference to the “image quality-related setting 2”.

### Classification of the Plurality of Sound-Related Settings

In addition, the analysis unit 320 may acquire a plurality of groups by classifying (or clustering) the plurality of sound-related settings based on i) the combination of the display device and the external device connected to the display device, and ii) the communication interface used for the connection between the display device and the external device. However, the analysis unit 320 is not limited thereto, and may acquire the plurality of groups by classifying the plurality of sound-related settings based on iii) the combination of the plurality of external devices 200 connected to the display device 100.

As an example, each of the plurality of groups may include at least one sound-related setting.

For example, a second group among the plurality of groups (e.g., a group in which the display device is connected to the external device based on i) a combination of the display device “K55NB8_” and the external device “GameBox_B” and ii) a first communication interface 110 according to the HDMI 2.0 standard) may include a “sound-related setting 1” and a “sound-related setting 2”.

As an example, the analysis unit 320 may acquire preference information corresponding to the plurality of sound-related settings (e.g., the “sound-related setting 1” and the “sound-related setting 2”) included in a second group, on the basis of a frequency (or the number of repetitions) of each of the “sound-related setting 1” and the “sound-related setting 2”.

For example, the “sound-related setting 1” selected (or set) by a relatively large number of users has a higher preference than the “sound-related setting 2” selected by a relatively small number of users, and the analysis unit 320 may thus recommend the “sound-related setting 1” in preference to the “sound-related setting 2”.

### Acquisition and Transmission of the Recommended Setting Information

Referring to FIG. 2, if the generation unit 330 included in the server 300 receives the identification information corresponding to the external device 200, the identification information corresponding to the display device 100, and the interface information from the display device 100, the generation unit 330 may identify one group corresponding to the identification information corresponding to the external device 200, the identification information corresponding to the display device 100, and the interface information among the plurality of groups.

Next, the generation unit 330 may acquire at least one image quality-related setting included in any one of the identified groups as the image quality-related recommended setting, and acquire at least one sound-related setting as the sound-related recommended setting.

Next, the generation unit 330 may transmit the recommended setting information including at least one of the image quality-related recommended setting or the sound-related recommended setting to the display device 100.

For example, if the generation unit 330 receives identification information “SoundBar_E” corresponding to the external device 200 and identification information “K75UN7_” corresponding to the display device 100 and the interface information “USB type-C” from the display device 100, the generation unit 330 may identify a fifth group among the plurality of groups, and acquire the image quality-related setting and the sound-related setting included in the fifth group as the image quality-related recommended setting and the sound-related recommended setting, respectively.

Next, the generation unit 330 may transmit the recommended setting information including at least one of the image quality-related recommended setting or the sound-related recommended setting to the display device 100.

Meanwhile, the display device 100 according to an example embodiment may acquire the first identification information corresponding to the external device 200 connected to each of the plurality of first communication interfaces 110, and acquire the recommended setting information by transmitting, to the external server, the first identification information corresponding to each of the plurality of external devices, the second identification information corresponding to the display device 100, and the interface information corresponding to each of the plurality of first communication interfaces 110.

### Classification of the Plurality of Setting Information Based on the Combination of the Plurality of External Devices 200 Connected to the Display Device 100

The various embodiments described above disclose an embodiment in which the server 300 receives, from the display device 100, the identification information corresponding to the external device 200 (e.g., the external device 200 providing the content currently being displayed on the display device 100), the identification information corresponding to the display device 100, and the interface information between the external device 200 and the display device 100, and acquires and transmits the recommended setting information on the basis of the identification information corresponding to the external device 200, the identification information corresponding to the display device 100, and the interface information between the external device 200 and the display device 100, among the plurality of groups, and is not limited thereto.

For example, the server 300 may acquire the recommended setting information in consideration of the plurality of external devices 200 connected to the display device 100 and transmit the same. For example, the server 300 may acquire the recommended setting information corresponding to a tendency (or preference or the like) the user of the display device 100, based on the identification information of each of the plurality of external devices 200 connected to the display device 100 and transmit the same.

As an example, if the server 300 identifies that a plurality of console game machines (different console game machines) are connected to the display device 100 on the basis of the identification information of each of the plurality of external devices 200 connected to the display device 100, the server 300 may acquire the recommended setting information appropriate for the console game machine (for example, the image quality-related setting or the sound-related setting set by the plurality of users who connect the console game machines to the display device 100 and use the display device 100) and transmit the recommended setting information to the display device 100.

As an example, if the plurality of external devices based on a specific operating system (e.g., Android™ or Windows™) are identified as being connected to the display device 100 on the basis of the identification information of each of the plurality of external devices 200 connected to the display device 100, the server 300 may acquire the recommended setting information appropriate for the specific operating system and transmit the recommended setting information to the display device 100.

To this end, the display device 100 may transmit the following information to the server 300: i) the identification information corresponding to the external device 200 (e.g., the input device) providing the content currently being displayed on the display device 100 or an external device 200′ (e.g., the output device) currently providing the audio signal to the display device 100; ii) the identification information corresponding to each of the plurality of external devices connected to the display device 100 (e.g., at least one external devices connected to the display device 100, regardless of whether the external device is turned on or off), or identification information corresponding to each of the plurality of external devices that have a history of being connected to the display device 100 (e.g., the external device that is not currently connected to the display device 100 and has a history of providing the content to the display device 100 or to which the display device 100 has a history of providing the signal); iii) the identification information corresponding to the display device 100; and iv) the interface information between the plurality of external devices and the display device 100.

Next, if the server 300 receives the identification information corresponding to each of the plurality of external devices 200 connected to the display device 100, the identification information corresponding to the display device 100, and the interface information of each of the plurality of external devices 200, the server 300 may acquire the recommended setting information in consideration of the tendency of the user of the display device 100 based on the plurality of external devices 200 connected to the display device 100 and transmit the same.

Hereinafter, the description more specifically describes a method for the server 300 to acquire the recommended setting information on the basis of the plurality of external devices 200 connected to the display device 100, that is, in consideration of the user tendency.

As an example, the server 300 may receive, from the display device 100, the setting information including at least one of the following: \textcircled{1} the identification information corresponding to each of the plurality of external devices 200 connected to the display device 100; \textcircled{2} the identification information corresponding to the display device 100; \textcircled{3} the interface information between the plurality of external devices 200 and the display device 100; and \textcircled{4} the image quality-related setting or sound-related setting of the display device 100.

As an example, if the server 300 receives the above-described \textcircled{1} to \textcircled{4} from each of the plurality of display devices 100 of different users, the server 300 may cluster the setting information of each of the plurality of display devices 100 on the basis of the combination of the plurality of external devices 200.

For example, the server 300 may cluster the setting information of the display devices to which the plurality of console game machines are connected on the basis of the combination of the plurality of external devices 200, and may cluster the setting information of the display devices to which the plurality of sound bars are connected.

For example, the server 300 may cluster the setting information of the display devices to which the external devices based on the specific operating system are connected on the basis of the combination of the plurality of external devices 200. In addition, the server 300 may cluster the setting information of the display devices connected to the plurality of external devices capable of providing the content having a specific resolution (e.g., 4K) or above, on the basis of the combination of the plurality of external devices 200.

The above-described embodiment is an example for the convenience of description, and the present disclosure is not limited thereto. As an example, the server 300 may cluster the setting information of the display devices to which the external devices of a specific manufacturer are connected on the basis of the combination of the plurality of external devices 200, and may cluster the setting information of the display devices to which the plurality of external devices that transmit and receive the signals via the specific interface (e.g., HDMI 2.1 or Thunderbolt™) are connected on the basis of the combination of the plurality of external devices 200.

Next, if the server 300 receives, from the display device 100, the identification information corresponding to each of the plurality of external devices 200 connected to the display device 100, the identification information of the display device 100, and the interface information of the plurality of external devices 200, the server 300 may acquire the recommended setting information by additionally considering the combination of the display device 100 and the external device 200 currently providing the content to the display device 100 (or the external device 200 to which the display device 100 provides the audio signal), the interface information between the display device 100 and the external device 200, and the combination of the plurality of external devices 200 connected to the display device 100, and transmit the same to the display device 100.

For example, the server 300 may input the following information received from the display device 100 into the neural network model: i) the identification information corresponding to the external device 200 (e.g., the input device) that provides the content currently being displayed or the external device 200′ to which the display device 100 currently provides the audio signal; ii) the identification information corresponding to each of the plurality of external devices 200 connected to the display device 100; iii) the identification information corresponding to the display device 100; and iv) the interface information between the plurality of external devices and the display device 100, and acquire the recommended setting information based on the combination of the display device 100 and the specific external device 200 (e.g., the external device 200 providing the content currently being displayed on the display device 100), the communication interface between the display device 100 and the specific external device 200, and the plurality of external devices 200 connected to the display device 100. A learning method of the neural network model is described below.

### Acquisition and Transmission of the Recommended Setting Information Using the Neural Network Model

According to an example embodiment, the server 300 may train the neural network model by using the plurality of setting information 10, 10′, and 10″ as training data.

As an example, the analysis unit 320 may train the neural network model by using the plurality of setting information 10, 10′, and 10″ as the training data, on the basis of the setting information corresponding to each of the plurality of combinations (e.g., the combination of the display device and the external device connected to the display device) and the interface information (e.g., the interface information corresponding to the communication interface used for the connection between the display device and the external device).

In addition, the analysis unit 320 may train the neural network model by using the plurality of setting information 10, 10′, and 10″ as the training data, on the basis of the setting information corresponding to the combination of the plurality of external devices 200 connected to each of the different display devices 100.

Next, if the generation unit 330 receives, from the display device 100, the identification information corresponding to the external device 200, the identification information corresponding to the display device 100, and the interface information, the generation unit 330 may input these information into the neural network model to thus acquire the recommended setting information corresponding to the combination of the display device 100 and the external device 200 and the communication interface information.

In addition, if the generation unit 330 receives, from the display device 100, the identification information corresponding to each of the plurality of external devices 200 connected to the display device 100, the generation unit 330 may input the identification information into the neural network model to thus acquire the recommended setting information corresponding to the combination of the display device 100 and the external device 200, the communication interface information, and the combination of the plurality of external devices 200 connected to the display device 100.

As an example, the neural network model may be a model trained to output the recommended setting information corresponding to the received information if the neural network model receives: i) a combination of a specific external device and a specific display device; and ii) interface information corresponding to a specific communication interface (or a communication interface used for connection between the specific display device and the specific external device).

In addition, the neural network model may be a model trained to output the recommended setting information corresponding to the received information if the neural network model receives: i) the combination of the specific external device and the specific display device; ii) the interface information corresponding to the specific communication interface (the communication interface used for the connection between the specific display device and the specific external device), and iii) a combination of the plurality of external devices connected to the specific display device.

Meanwhile, for the convenience of description, the operations of the collection unit 310, the analysis unit 320, and the generation unit 330 are described separately. However, each operation of the collection unit 310, the analysis unit 320, and the generation unit 330 may also be implemented as an operation of the processor included in the server 300. In addition, such an operation may be implemented as an operation of at least one processor 140 included in the display device 100 instead of the server 300.

As an example, an artificial intelligence-related function according to the present disclosure may be operated using the processor and the memory included in the display device 100. The processor may include one or more processors. Here, one or more processors may include at least one of a central processing unit (CPU), a graphic processing unit (GPU), or a neural processing unit (NPU), or at least one processor may be implemented in a coupled form with at least one heterogeneous processor, and is not limited to the examples of the processors described above.

The CPU is a general-purpose processor that may perform not only general operations but also artificial intelligence operations, and may efficiently execute complex programs through a multi-layered cache structure. The CPU may be advantageous for a serial processing method that enables organic linkage between a previous operation result and the next operation result through sequential operation. The general-purpose processor is not limited to the above-described example, unless specified as the above-mentioned CPU.

The GPU is a processor for large-scale operations such as floating-point operations used for graphics processing, and may perform the large-scale operations in parallel by integrating a large number of cores. In particular, the GPU may be advantageous for a parallel processing method such as a convolution operation or the like compared to the CPU. In addition, the GPU may be used as a co-processor to supplement the function of the CPU. The processor for the large-scale operations is not limited to the above-described example, unless specified as the above-mentioned GPU.

The NPU is a processor specialized for artificial intelligence operation using an artificial neural network, and each layer included in the artificial neural network may be implemented in hardware (e.g., silicon). Here, the NPU is specially designed based on requirements of a company, and may have a lower degree of freedom than the CPU or the GPU. However, the NPU may efficiently process the artificial intelligence operation required by the company. Meanwhile, as the processor specialized for the artificial intelligence operation, the NPU may be implemented in various forms such as a tensor processing unit (TPU), an intelligence processing unit (IPU), a vision processing unit (VPU), etc. The artificial intelligence processor is not limited to the above-described example, unless specified as the above-mentioned NPU.

In addition, one or more processors may be implemented in a system on chip (SoC). Here, the SoC may further include a memory and a network interface such as a bus for data communication between the processor and the memory in addition to one or more processors.

If the system on chip (SoC) included in the display device 100 includes a plurality of processors, the display device 100 may use some of the plurality of processors to perform the artificial intelligence operation (e.g., operation related to the learning or inference of an artificial intelligence model). For example, the display device 100 may perform the artificial intelligence operation by using at least one of the GPU, the NPU, the VPU, the TPU, or the hardware accelerator that is specialized for the artificial intelligence operation such as convolution operation and matrix multiplication operation among the plurality of processors. However, this configuration is only an example, and the artificial intelligence operation may be processed using the general-purpose processor such as the CPU.

In addition, the display device 100 may perform operation for the artificial intelligence-related function by using the multiple cores (e.g., dual-core or quad-core) included in one processor. In particular, the display device 100 may perform the artificial intelligence operation such as the convolution operation and the matrix multiplication operation in parallel using the multiple cores included in the processor.

One or more processors may control input data to be processed based on a predefined operation rule or the artificial intelligence model stored in the memory. The predefined operation rule or the artificial intelligence model may be acquired by learning.

Here, “acquired by learning” may indicate that the predefined operation rule or artificial intelligence model of a desired feature is acquired by applying a learning algorithm to a lot of training data. Such learning may be performed on the device itself on which the artificial intelligence is performed according to the present disclosure, or by a separate server/system.

The artificial intelligence model may include a plurality of neural network layers. At least one layer has at least one weight value, and an operation of the layer may be performed through an operation result of a previous layer and at least one defined operation. The neural networks may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), a deep Q-network, and a transformer. However, the neural network of the present disclosure is not limited to the above-described examples, unless specified otherwise.

The learning algorithm is a method of training a predetermined target device (e.g., a robot) by using a large number of training data for the predetermined target device to make a decision or a prediction for itself. The learning algorithms may include, for example, a supervised learning algorithm, an unsupervised learning algorithm, a semi-supervised learning algorithm, or a reinforcement learning algorithm. However, the learning algorithm of the present disclosure is not limited to the above-described examples, unless specified otherwise.

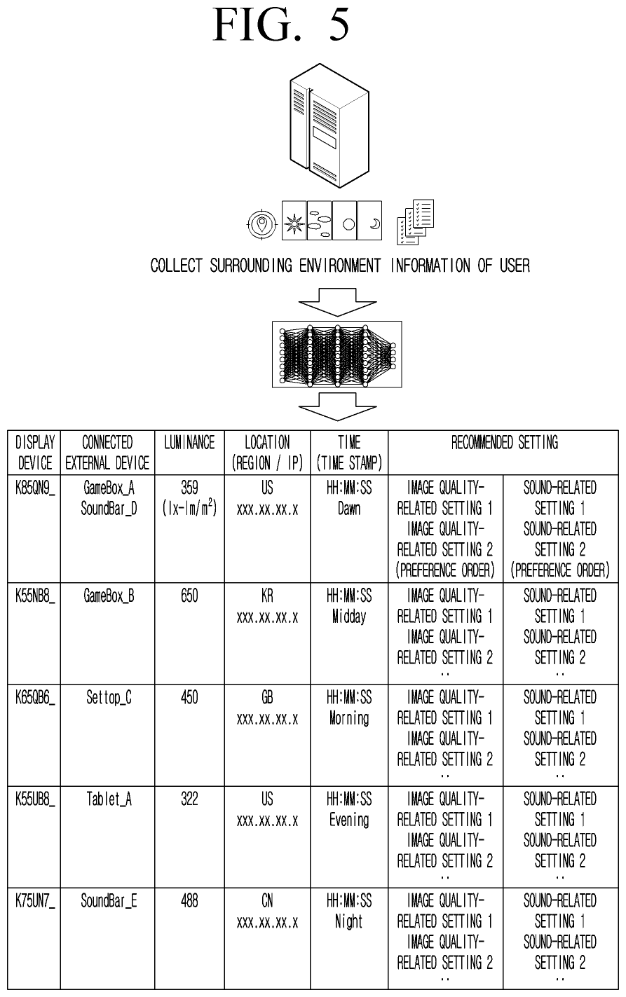

FIG. 5 is a diagram for describing the neural network model that acquires the recommended setting information by using surrounding environment information according to an example embodiment.

Referring to FIG. 4, the description describes an implementation example of acquiring the recommended setting information by using the identification information of the display device 100, the identification information of the external device 200, and the interface information. However, Referring to FIG. 5, the recommended setting information may be acquired by additionally considering the surrounding environment information of the display device 100.

As an example, the display device 100 may include a luminance sensor. At least one processor 140 may acquire ambient luminance information of the display device 100 from the luminance sensor. For example, the ambient luminance information may have a value ranging from zero to 1023, and a larger value may indicate lower ambient luminance (darkness), and a smaller value may indicate higher ambient luminance (brightness). However, this configuration is an example and is not limited thereto.

In addition, the display device 100 may acquire location information on the basis of layout, system language, or region information corresponding to a user selection in the OOBE phase, an internet protocol (IP) address of the display device 100, or the like.

In addition, the display device 100 may acquire time information on the basis of system time, time received from the external server 300, or the like.

Next, the display device 100 may acquire the surrounding environment information including at least one of the ambient luminance information, the location information, or the time information, and transmit, to the external server 300, the identification information corresponding to the display device 100, the identification information corresponding to the external device 200, the interface information, and the surrounding environment information.

Next, if at least one processor 140 receives the recommended setting information, the processor 140 may change the setting of the display device 100 on the basis of the received recommended setting information.

### Classification Based on the Surrounding Environment Information

As an example, the identification information transmitted from the display device 100 to the external server 300 may include the surrounding environment information including at least one of the ambient luminance information, the location information, or the time information.

As an example, the analysis unit 320 may classify the plurality of image quality-related settings and the plurality of sound-related settings included in the plurality of setting information 10, 10′, and 10″ based on i) the combination of the display device and the external device connected to the display device, ii) the communication interface used for the connection between the display device and the external device, and iii) the surrounding environment information.

Meanwhile, if the generation unit 330 receives, from the display device 100, the identification information corresponding to the external device 200, the identification information corresponding to the display device 100, the interface information, and the surrounding environment information, the generation unit 330 may identify, among the plurality of groups, any one group corresponding to the identification information corresponding to the external device 200, the identification information corresponding to the display device 100, the interface information, and the surrounding environment information.

For example, among the plurality of groups, one group matching the identification information corresponding to the external device 200, the identification information corresponding to the display device 100, and the interface information may be identified. However, among the plurality of groups, one group matching the surrounding environment information may not be identified.

For example, any one group matching the ambient luminance information, the location information, and the time information, received from the display device 100, may not be identified, and the generation unit 330 may thus identify any one group having a similarity equal to or greater than a threshold value with the surrounding environment information received from the display device 100.

For example, if the generation unit 330 receives, from the display device 100, the identification information “GameBox_B” corresponding to the external device 200 and the identification information “K55NB8_” corresponding to the display device 100, the interface information “HDMI 2.1”, and the surrounding environment information (ambient luminance information “600”, location information “CN”, time information “1 PM”), the generation unit 330 may identify, among the plurality of groups, a second group matching the identification information “GameBox_B” corresponding to the external device 200 and the identification information “K55NB8_” corresponding to the display device 100, the interface information “HDMI 2.1”, and having the ambient luminance information having a similarity equal to or greater than the threshold value (for example, a difference in ambient luminance is within the threshold value (e.g., 100), the location information corresponds to an adjacent region (e.g., the same continent), and a time difference is within the threshold value (e.g., 2 hours)) and acquire the image quality-related setting and the sound-related setting included in the second group as the image quality-related recommended setting and the sound-related recommended setting, respectively.

Next, the generation unit 330 may transmit the recommended setting information including at least one of the image quality-related recommended setting or the sound-related recommended setting to the display device 100.

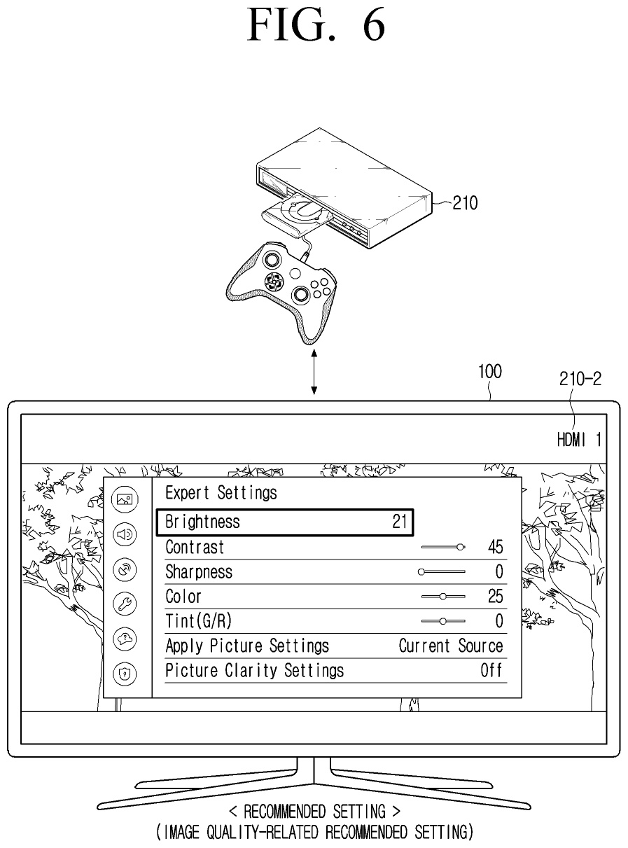

FIG. 6 is a diagram for describing the image quality-related recommended setting according to an example embodiment.

Referring to FIG. 6, the image quality-related recommended setting included in the recommended setting information received from the server 300 may include a recommended setting value corresponding to each of the various settings related to an image quality of the display device 100.

For example, the image quality-related recommended setting may include the recommended setting related to at least one of contrast, color tone, gamma value, on/off of contrast enhancer, frame rate (e.g., 60 Hz, 120 Hz, or 144 Hz), on/off of motion interpolation, brightness, sharpness, high dynamic range (HDR)/standard dynamic range (SDR), or aspect ratio (16:9 or 16:10).

However, the image quality-related recommended setting is not limited to the above-described example, and may include the recommended setting value corresponding to each of the various settings related to the image quality of the display device 100.

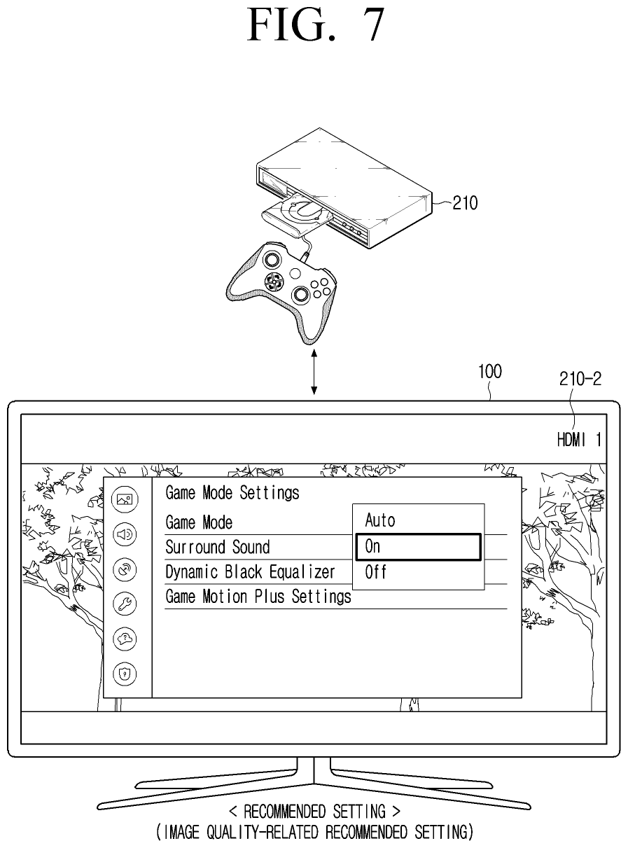

FIG. 7 is a diagram for describing the image quality-related

recommended setting according to an example embodiment.

For example, referring to FIG. 7, if the display device 100 supports a plurality of display modes, such as a movie mode and a game mode, the image quality-related recommended setting may include the recommended setting value for the display mode on the basis of i) the combination of the display device 100 and the external device 200 and ii) the information corresponding to the first communication interface 110 used for the connection between the display device and the external device 200.

For example, if the first external device 210 connected to the display device 100 is the console game machine, the display mode included in the image quality-related recommended setting received from the external server 300 may include the recommended setting value corresponding to each of the game mode and a detailed setting of the game mode.

Accordingly, if the user of the display device 100 connects the console game machine to the display device 100 and uses the console game machine, at least one processor 130 may automatically change the image quality-related setting of the display device 100 to be appropriate and optimized for the console game machine by using the image quality-related recommended setting received from the external server 300, without having to manually change each of the game mode and the detailed setting of the game mode.

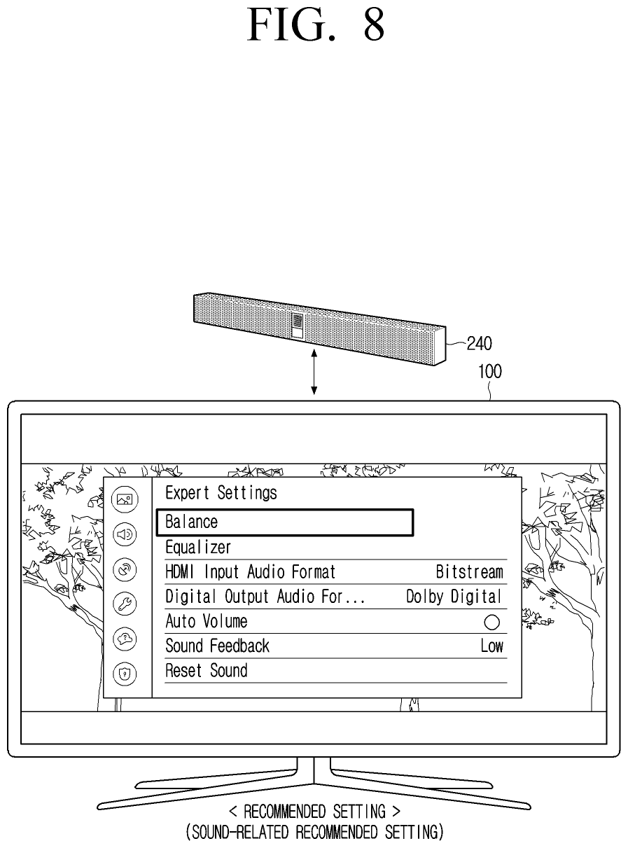

FIG. 8 is a diagram for describing the sound-related recommended

setting according to an example embodiment.

Referring to FIG. 8, the sound-related recommended setting included in the recommended setting information received from the server 300 may include the recommended setting value corresponding to each of the various settings related to sound of the display device 100.

For example, the sound-related recommended setting may include the recommended setting related to at least one of the detailed setting such as sound output mode, equalizer, sound magnitude, balance, digital output format (e.g., Dolby Digital), audio return channel (ARC), or enhanced ARC (eARC) support.

Meanwhile, if the external device 200 is the sound output device (e.g., the sound bar), at least one processor 140 may control the sound output device to change a setting of the sound output device on the basis of the sound-related recommended setting.

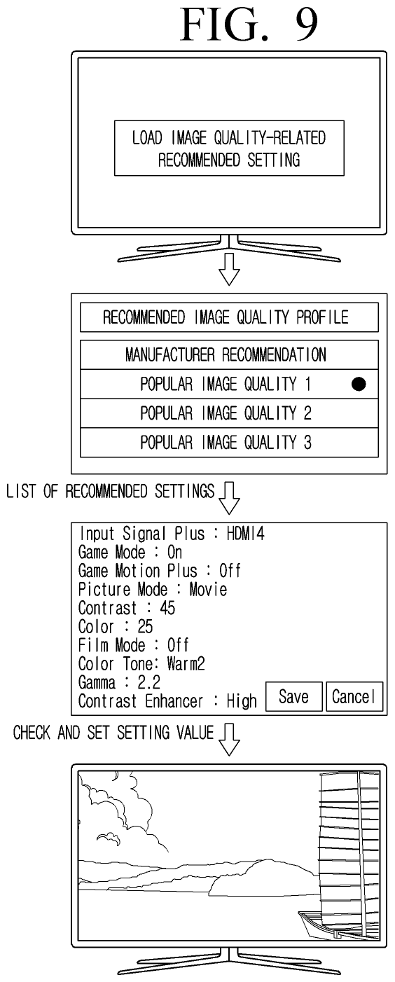

FIG. 9 is a diagram for describing a list of the plurality of image quality-related recommended settings according to an example embodiment.

Referring to FIG. 9, at least one processor 140 may provide a user interface (UI) for receiving the recommended setting information related to the image quality.

As an example, if the reception of the recommended setting information related to the image quality is requested according to the user command through the UI, at least one processor 140 may acquire the recommended setting information corresponding to the identification information of the display device 100, the identification information of the external device 200, and the interface information.

Next, at least one processor 140 may provide a UI for selecting whether to apply the image quality-related recommended setting before changing the setting of the display device 100 on the basis of the image quality-related recommended setting.

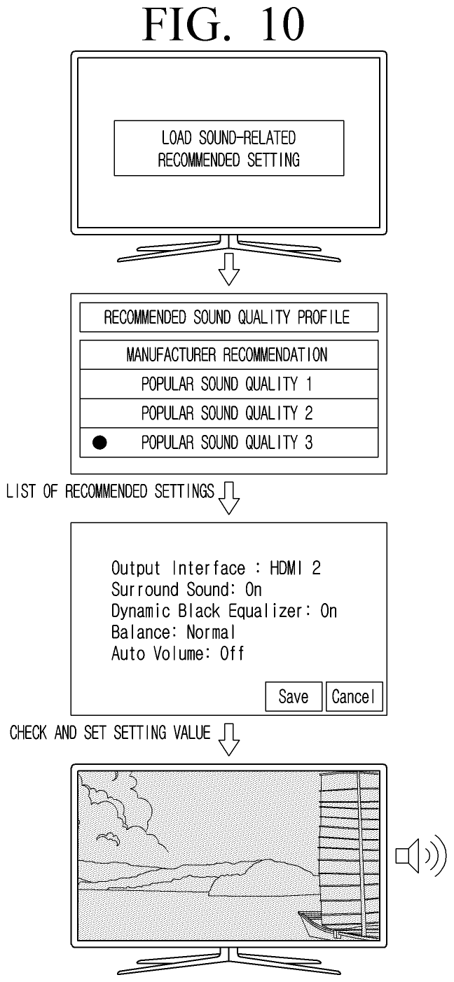

FIG. 10 is a diagram for describing a list of the plurality of sound-related recommended settings according to an example embodiment.

Referring to FIG. 10, at least one processor 140 may provide the UI (User Interface) for receiving the recommended setting information related to sound.

As an example, if the reception of the recommended setting information related to sound is requested according to the user command through the UI, at least one processor 140 may acquire the recommended setting information corresponding to the identification information of the display device 100, the identification information of the external device 200, and the interface information.

Next, at least one processor 140 may provide a UI for selecting whether to apply the sound-related recommended setting before changing the setting of the display device 100 on the basis of the sound-related recommended setting.

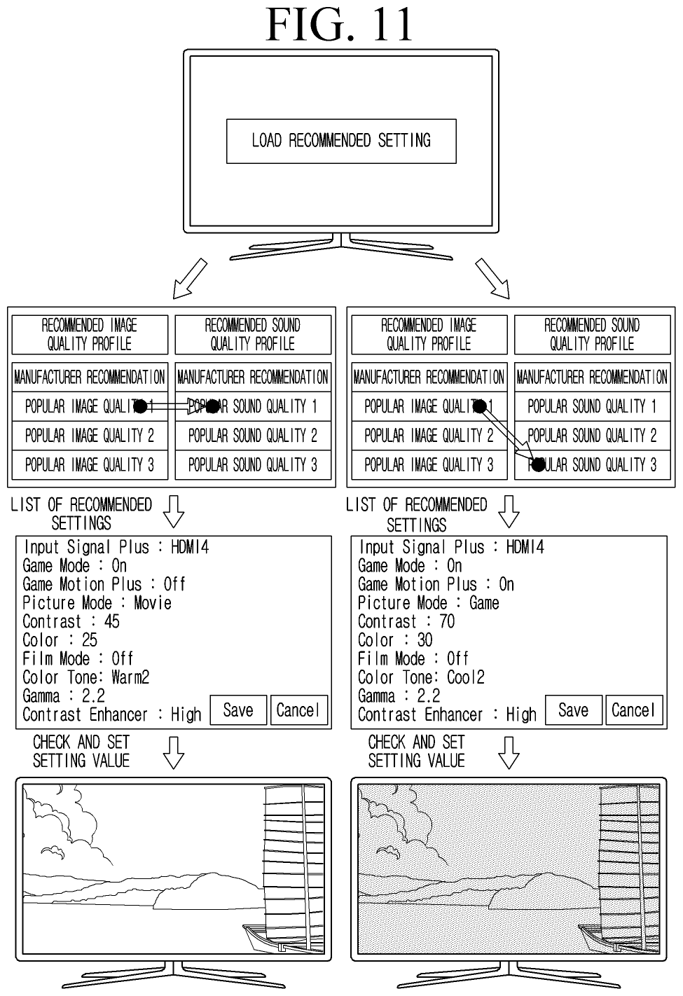

FIG. 11 is a diagram for describing a list of the plurality of recommended settings according to an example embodiment.

Referring to FIG. 11, at least one processor 140 may provide the user interface (UI) for receiving the recommended setting information including at least one of the recommended setting information related to the image quality or the recommended setting information related to sound.

As an example, if the reception of the recommended setting information is requested according to the user command through the UI, at least one processor 140 may acquire the recommended setting information corresponding to the identification information of the display device 100, the identification information of the external device 200, and the interface information.

Next, at least one processor 140 may provide a UI for selecting whether to apply the image quality-related recommended setting and the sound-related recommended setting before changing the setting of the display device 100 on the basis of the recommended setting information.

For example, if the recommended setting information includes the plurality of recommended settings, at least one processor 140 may provide a UI for selecting any one of the plurality of recommended settings.

As an example, at least one processor 140 may arrange the plurality of image quality-related recommended settings on the basis of the preference information corresponding to each of the image quality-related recommended settings, and then provide a UI for selecting one of the plurality of image quality-related recommended settings.

In addition, at least one processor 140 may arrange the plurality of sound-related recommended settings on the basis of the preference information corresponding to each of the sound-related recommended settings, and then provide a UI for selecting one of the plurality of sound-related recommended settings.

As an example, at least one processor 140 may provide the UI for selecting whether to apply the image quality-related recommended setting and the sound-related recommended setting before changing the setting of the display device 100 on the basis of the image quality-related recommended setting and the sound-related recommended setting, selected through the UI (e.g., before applying the setting).

Here, the UI for selecting whether to apply the setting may provide the plurality of recommended setting values included in the selected image quality-related recommended setting and sound-related recommended setting, and at least one of the plurality of recommended setting values may be manually changed to another setting value based on the user input through the UI and then applied.

Meanwhile, each of the UIs shown in FIGS. 9 and 10 is the UI for receiving either the image quality-related recommended setting or the sound-related recommended setting, and the UI shown in FIG. 11 may be the UI for receiving both the image quality-related recommended setting and the sound-related recommended setting, or the UI for receiving at least one of the image quality-related recommended setting or the sound-related recommended setting that is appropriate (or optimized) for a current state of the display device 100 from the server 300.

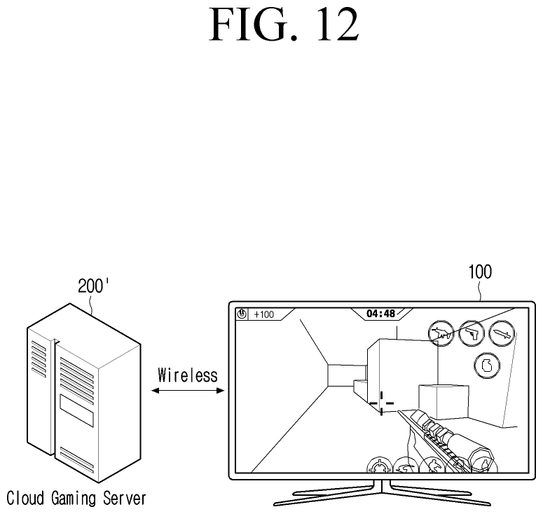

FIG. 12 is a diagram for describing the external device according to an example embodiment.

The above-described various embodiments are described assuming that the display device 100 and the external device 200 are connected to each other in a wired manner through the first communication interface, which is only an example, and the present disclosure is not limited thereto.

Referring to FIG. 12, the display device 100 may receive the content from the external device 200′, and the external device 200′ and the display device 100 may be connected to each other in a wireless manner. Here, the external device 200′ may include a cloud gaming server, an OTT streaming Server, or the like.

As an example, at least one processor 140 may transmit, to the server, the identification information of the display device 100, the identification information of the external device 200′, and the interface information corresponding to the wireless manner.

Here, the interface information corresponding to the wireless manner may include frequency band, bandwidth, and wireless signal strength, or the like based on the wireless communication manner.

At least one processor 140 according to an example embodiment may change the image quality-related setting, sound-related setting, or the like of the display device 100 on the basis of the recommended setting information corresponding to the combination of the display device 100 and the external device 200 and the frequency band (e.g., 5 GHz or 2.4 GHz), bandwidth, wireless signal strength, or the like based on the wireless communication manner.

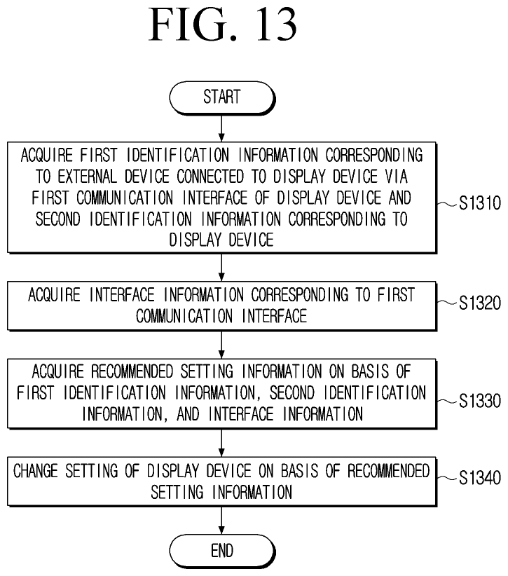

FIG. 13 is a flowchart for describing a control method of a display device according to an example embodiment.

The control method of a display device according to an example embodiment may first include acquiring the first identification information corresponding to the external device connected to the display device via the first communication interface of the display device and the second identification information corresponding to the display device (S1310).

Next, the method may include acquiring the interface information corresponding to the first communication interface (S1320).

Next, the method may include acquiring the recommended setting information on the basis of the first identification information, the second identification information, and the interface information (S1330).

Next, the method may include changing the setting of the display device on the basis of the recommended setting information (S1340).

The recommended setting information according to an example embodiment may include at least one of the combination of the display device and the external device or the image quality-related recommended setting or sound-related recommended setting of the display device that corresponds to the interface information.

Step S1330 of acquiring the recommended setting information according to an example embodiment may include transmitting, to the external server, the first identification information, the second identification information, and the interface information, and Step S1340 of the changing may include changing at least one of the image quality-related setting or sound-related setting of the display device on the basis of the recommended setting information if the recommended setting information is received from the external server.

The control method according to an example embodiment may further include acquiring the surrounding environment information including at least one of the ambient luminance information, location information, and time information of the display device, and Step S1330 of acquiring the recommended setting information may include acquiring the recommended setting information on the basis of the first identification information, the second identification information, the interface information, and the surrounding environment information.

The recommended setting information according to an example embodiment may include the plurality of recommended settings. As an example, the control method may further include providing the user interface (UI) for selecting any one of the plurality of recommended settings, and Step S1340 of the changing may include changing the setting of the display device on the basis of the selected recommended setting if any one of the plurality of recommended settings is selected through the UI.

Here, the recommended setting information may include the preference information for each of the plurality of recommended settings, and the providing of the UI may include arranging the plurality of recommended settings based on the preference information and providing the same through the UI. “Based on” as used herein covers based at least on.

According to an example embodiment, Step S1320 of acquiring the interface information may include acquiring the first identification information corresponding to the first communication interface to which the external device is connected, the external device providing the content currently being displayed on the display device, among the plurality of first communication interfaces, and the interface information corresponding to the first communication interface, wherein the interface information may include the standard information of the first communication interface.

Step S1310 of acquiring the first and second identification information according to an example embodiment may include acquiring the first identification information corresponding to the external device connected to each of the plurality of first communication interfaces, and Step S1330 of acquiring the recommended setting information may include acquiring the recommended setting information by transmitting, to the external server, the first identification information corresponding to each of the plurality of external devices, the second identification information, and the interface information corresponding to each of the plurality of first communication interfaces.

The control method according to an example embodiment may further include acquiring the setting information including at least one of the image quality-related setting or sound-related setting of the display device, and transmitting, to the external server, the first identification information, the second identification information, the acquired setting information, and the interface information.

The control method according to an example embodiment may include acquiring the recommended setting information corresponding to the combination of the display device and the external device and the interface information of the first communication interface by using the neural network model trained to output the recommended setting information corresponding to the combination of the specific external device and the specific display device and the interface information corresponding to the specific communication interface if the first identification information corresponding to the specific external device, the second identification information corresponding to the specific display device, and the interface information corresponding to the specific communication interface are input, wherein the neural network model is trained on the basis of the setting information corresponding to each of the plurality of combinations and the interface information, and may be provided to the external server.

The image quality-related recommended setting according to an example embodiment may include the recommended setting related to at least one of display mode, contrast, color tone, gamma value, contrast enhancer, frame rate, brightness, sharpness, high dynamic range (HDR)/standard dynamic range (SDR), or aspect ratio, the sound-related recommended setting may include the recommended setting related to at least one of sound output mode, equalizer, sound size, balance, or digital output format, and Step S1340 of the changing may include changing the setting of the sound output device on the basis of the sound-related recommended setting if the external device is the sound output device.

However, the various embodiments of the present disclosure may be applied not only to the display device but also to the various types of electronic devices.

Meanwhile, the various embodiments of the present disclosure described above may be implemented in a recording medium readable by a computer or similar device using software, hardware, or a combination thereof. In some cases, the embodiments described in the specification may be implemented by the processor itself. In software implementation, the embodiments such as the procedures and functions described in this specification may be implemented by separate software modules. Each of the software modules may perform one or more functions and operations described in the specification.

Meanwhile, a non-transitory computer-readable medium may store computer instructions for performing processing operations of the electronic device according to the various embodiments of the present disclosure described above. The computer instructions stored in the non-transitory computer-readable medium may allow a specific device to perform the processing operations of the electronic device according to the various embodiments described above if executed by a processor of the specific device.

The non-transitory computer-readable medium indicates a medium that semi-permanently stores data therein and is readable by the machine instead of a medium that stores data therein temporarily, such as a register, a cache, or a memory. A specific example of the non-transitory computer-readable medium may include a compact disk (CD), a digital versatile disk (DVD), a hard disk, a blu-ray disk, a universal serial bus (USB), a memory card, a read only memory (ROM), or the like.

Although the embodiments are shown and described in the present disclosure as above, the present disclosure is not limited to the above-described specific embodiments, and may be variously modified by those skilled in the art to which the present disclosure pertains without departing from the gist of the present disclosure as claimed in the accompanying claims. These modifications should also be understood to fall within the scope and spirit of the present disclosure.

1. A display device comprising:
a first communication interface comprising interface circuitry; and
at least one processor, comprising processing circuitry, individually and/or collectively configured to:
acquire first identification information corresponding to an external device to be connected to the display device via the first communication interface and second identification information corresponding to the display device,
acquire interface information corresponding to the first communication interface,
acquire recommended setting information based on the first identification information, the second identification information, and the interface information, and
change a setting of the display device based on the recommended setting information,
wherein the recommended setting information includes at least one of: a combination of the display device and the external device, or the image quality-related recommended setting and/or sound-related recommended setting of the display device that corresponds to the interface information.

2. The device as claimed in claim 1, further comprising a second communication interface comprising interface circuitry,
wherein the at least one processor is individually and/or collectively configured to:
control the second communication interface to transmit, to an external server, the first identification information, the second identification information, and the interface information, and
change at least one of the image quality-related setting or sound-related setting of the display device on the basis of the recommended setting information when the recommended setting information is received from the external server.

3. The device as claimed in claim 1, wherein the at least one processor is individually and/or collectively configured to:
acquire surrounding environment information including at least one of ambient luminance information, location information, or time information of the display device, and
acquire the recommended setting information based on the first identification information, the second identification information, the interface information, and the surrounding environment information.

4. The device as claimed in claim 1, wherein the recommended setting information includes a plurality of recommended settings, and
the at least one processor is individually and/or collectively configured to:
provide a user interface (UI) for selecting any one of the plurality of recommended settings, and
change the setting of the display device based on the selected recommended setting when any one of the plurality of recommended settings is selected through the UI.

5. The device as claimed in claim 4, wherein the recommended setting information includes preference information for each of the plurality of recommended settings, and
the at least one processor is individually and/or collectively configured to arrange the recommended settings based on the preference information and provide the arranged plurality of recommended settings through the UI.

6. The device as claimed in claim 1, wherein the at least one processor is individually and/or collectively configured to acquire the first identification information corresponding to the first communication interface to which the external device is connected, the external device providing content currently being displayed on the display device, among the plurality of first communication interfaces, and the interface information corresponding to the first communication interface, and
the interface information includes standard information of the first communication interface.

7. The device as claimed in claim 6, wherein the at least one processor is individually and/or collectively configured to:
acquire the first identification information corresponding to the external device connected to each of the plurality of first communication interfaces, and
acquire the recommended setting information at least by transmitting, to the external server, the first identification information corresponding to each of the plurality of external devices, the second identification information, and the interface information corresponding to each of the plurality of first communication interfaces.

8. The device as claimed in claim 1, further comprising a second communication interface comprising circuitry,
wherein the at least one processor is individually and/or collectively configured to:
acquire setting information including at least one of the image quality-related setting or sound-related setting of the display device, and
control the second communication interface to transmit, to an external server, the first identification information, the second identification information, the acquired setting information, and the interface information.

9. The device as claimed in claim 8, wherein the at least one processor is individually and/or collectively configured to acquire the recommended setting information corresponding to the combination of the display device and the external device and the interface information of the first communication interface at least by using a neural network model trained to output the recommended setting information corresponding to a combination of a specific external device and a specific display device and interface information corresponding to a specific communication interface when the processor receives the first identification information corresponding to the specific external device, the second identification information corresponding to the specific display device, and the interface information corresponding to the specific communication interface, and
the neural network model is trained based on the setting information corresponding to each of the plurality of combinations and the interface information, and is to be provided to the external server.

10. The device as claimed in claim 1, wherein the image quality-related recommended setting includes a recommended setting related to at least one of display mode, contrast, color tone, gamma value, contrast enhancer, frame rate, brightness, sharpness, high dynamic range (HDR)/standard dynamic range (SDR), or aspect ratio,
the sound-related recommended setting includes a recommended setting related to at least one of sound output mode, equalizer, sound size, balance, or digital output format, and
the at least one processor is individually and/or collectively configured to change a setting of a sound output device on the basis of the sound-related recommended setting if the external device is the sound output device.

11. A control method of a display device, the method comprising:
acquiring first identification information corresponding to an external device connected to the display device via a first communication interface of the display device and second identification information corresponding to the display device;
acquiring interface information corresponding to the first communication interface;
acquiring recommended setting information based on the first identification information, the second identification information, and the interface information; and
changing a setting of the display device based on the recommended setting information,
wherein the recommended setting information includes at least one of: a combination of the display device and the external device or the image quality-related recommended setting or sound-related recommended setting of the display device that corresponds to the interface information.

12. The method as claimed in claim 11, wherein the acquiring of the recommended setting information includes transmitting, to an external server, the first identification information, the second identification information, and the interface information, and
the changing includes changing at least one of the image quality-related setting or sound-related setting of the display device based on the recommended setting information when the recommended setting information is received from the external server.

13. The method as claimed in claim 11, further comprising acquiring surrounding environment information including at least one of the ambient luminance information, location information, or time information of the display device,
wherein the acquiring of the recommended setting information includes acquiring the recommended setting information based on the first identification information, the second identification information, the interface information, and the surrounding environment information.

14. The method as claimed in claim 11, in which the recommended setting information includes a plurality of recommended settings, further comprising providing a user interface (UI) for selecting any one or more of the plurality of recommended settings,
wherein the changing includes changing the setting of the display device based on the selected recommended setting when any one of the plurality of recommended settings is selected through the UI.

15. The method as claimed in claim 14, in which the recommended setting information includes preference information for each of the plurality of recommended settings, further comprising arranging the recommended settings based on the preference information and provide the arranged plurality of recommended settings through the UI.

16. The method as claimed in claim 11, further comprising acquiring the first identification information corresponding to the first communication interface to which the external device is connected, the external device providing content currently being displayed on the display device, among the plurality of first communication interfaces, and the interface information corresponding to the first communication interface, and
the interface information includes standard information of the first communication interface.

17. The method as claimed in claim 16, further comprising acquiring the first identification information corresponding to the external device connected to each of the plurality of first communication interfaces, and
acquiring the recommended setting information at least by transmitting, to the external server, the first identification information corresponding to each of the plurality of external devices, the second identification information, and the interface information corresponding to each of the plurality of first communication interfaces.

18. A non-transitory computer-readable medium storing a computer instruction for causing a display device to perform an operation when executed by a processor of the display device, wherein the operation includes:
acquiring first identification information corresponding to an external device connected to the display device via a first communication interface of the display device and second identification information corresponding to the display device,
acquiring interface information corresponding to the first communication interface;
acquiring recommended setting information based on the first identification information, the second identification information, and the interface information, and
changing a setting of the display device based on the recommended setting information, and
the recommended setting information includes at least one of a combination of the display device and the external device or the image quality-related recommended setting or sound-related recommended setting of the display device that corresponds to the interface information.

19. The non-transitory computer readable medium of claim 18, wherein the acquiring of the recommended setting information includes transmitting, to an external server, the first identification information, the second identification information, and the interface information, and
the changing includes changing at least one of the image quality-related setting or sound-related setting of the display device based on the recommended setting information when the recommended setting information is received from the external server.

20. The non-transitory computer readable medium of claim 18, further comprising acquiring surrounding environment information including at least one of the ambient luminance information, location information, or time information of the display device,
wherein the acquiring of the recommended setting information includes acquiring the recommended setting information based on the first identification information, the second identification information, the interface information, and the surrounding environment information.
